(19) United States
(12) Patent Application Publication
(10) Pub. No.: US 2014/0176787 A1
(43) Pub. Date: Jun. 26, 2014

(54) AUXILIARY CAMERA LENS ATTACHMENT AND LIGHT PIPE FOR AN ELECTRONIC DEVICE

(71) Applicant: INTEL CORPORATION, Santa Clara, CA (US)

(72) Inventors: Xiaofeng Sheng, Shanghai (CN); Russell Beauregard, Portland, OR (US); Shanjun Deng, Shanghai (CN)

(21) Appl. No.: 13/977,007

(22) PCT Filed: Dec. 21, 2012
(86) PCT No.: PCT/CN2012/087179

§ 371 Date: Jun. 27, 2013

(51) Int. Cl. H04N 5/225

(52) U.S. Cl. CPC H04N 5/2254; H04N 5/2256
USPC 348/360

(57) ABSTRACT

Particular embodiments described herein provide for an electronic computing device including a processor, a memory element, a camera module, and a housing including an alignment structure associated therewith for aligning a lens with the camera module. The electronic computing devices further includes a housing attachment structure associated with the alignment structure for attaching the lens to the housing. The lens includes a first structure portion including a lens attachment structure, and an image transformation portion coupled to the first structure. The lens attachment structure is configured to engage the housing attachment structure, and the alignment structure is configured to position the image transformation portion in a predetermined alignment with the camera module.

### TECHNICAL HELD

Embodiments described herein generally relate to an auxiliary camera lens attachment and light pipe for an electronic device.

### BRIEF DESCRIPTION OF THE DRAWINGS

Embodiments are illustrated by way of example and not by way of limitation in the FIGURES of the accompanying drawings, in which like references indicate similar elements and in which:

FIG. 1 is a simplified cross-sectional diagram illustrating an embodiment of a lens assembly of an auxiliary camera lens attachment to an electronic device;

FIG. 2A is a simplified diagram of a cross-sectional orthogonal view of the lens assembly of FIG. 1;

FIG. 2B is a simplified diagram of an exploded orthogonal view of the lens assembly of FIG. 1;

FIG. 3 is a simplified cross-sectional diagram illustrating another embodiment of an integrated lens assembly of an auxiliary camera lens attachment for an electronic device;

FIGS. 4A-4B are simplified diagrams of an orthogonal view of an embodiment of the coupling of the integrated lens assembly of FIG. 3 to a housing of the electronic device;

FIG. 5A is a simplified diagram illustrating an orthogonal rear view of an embodiment of an electronic device configured to receive the integrated lens assembly;

FIG. 5B is a simplified diagram illustrating an orthogonal front view of the electronic device;

FIG. 6 is a simplified diagram illustrating an example operation of the electronic device of FIGS. 5A-5B;

FIG. 7 is a simplified diagram illustrating an orthogonal front view of another embodiment of an electronic device configured to receive the integrated lens assembly in an open configuration;

FIG. 8 is a simplified block diagram of an embodiment of an electronic device configured to receive the integrated lens assembly; and

FIG. 9 is a flow diagram illustrating an example operation of the electronic device having the integrated lens assembly coupled thereto.

### DETAILED DESCRIPTION OF EXAMPLE EMBODIMENTS

The following detailed description sets forth example embodiments of apparatuses, methods, and systems relating to hinge configurations for an electronic device. Features such as structure(s), function(s), and/or characteristic(s), for example, are described with reference to one embodiment as a matter of convenience; various embodiments may be implemented with any suitable one or more of the described features.

Traditional electronic devices (e.g., laptops, notebook computers, etc.) follow design considerations in which a camera module is generally positioned in a housing of the electronic device allowing a user of the electronic device to capture images of objects in the environment. Typically, the camera module includes a relatively small lens lacking an ability to provide a macro view of an object. In addition, traditional electronic devices lack the capability of accurately aligning and holding an attached lens to a camera module.

### Auxiliary Camera Lens Attachment and Light Pipe for an Electronic Device

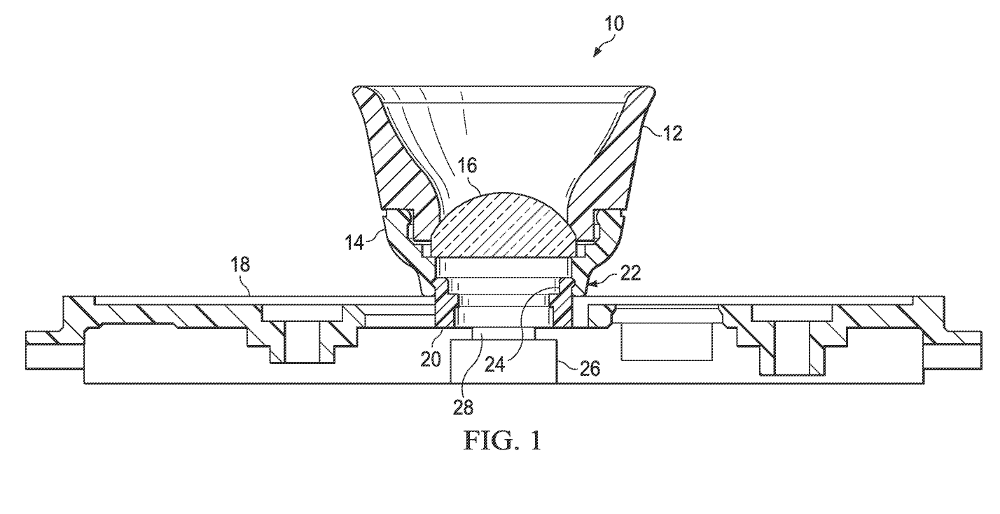

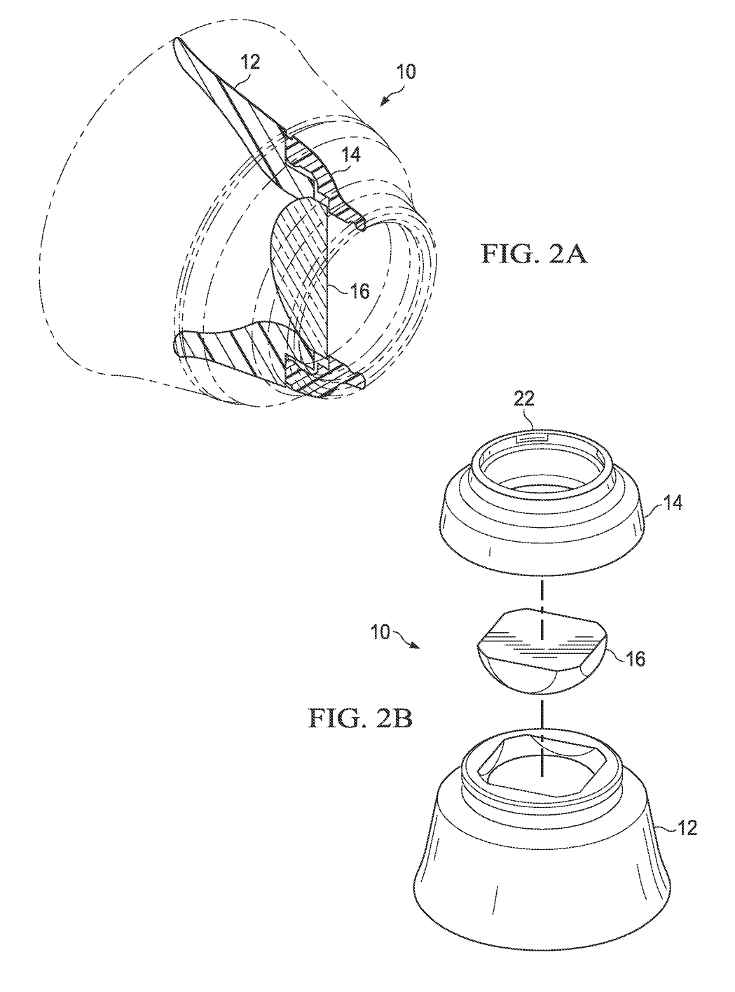

FIG. 1 is a simplified cross-sectional diagram illustrating an embodiment of a lens assembly 10 of an auxiliary camera lens attachment to an electronic device. FIG. 2A is a simplified diagram of a cross-sectional orthogonal view of lens assembly 10 of FIG. 1. FIG. 2B is a simplified diagram of an exploded orthogonal view of lens assembly 10 of FIG. 1. In various embodiments, the electronic device may include any electronic computing device or any other electronic device configured to include image capture and/or camera functionality such as a smartphone, tablet, desktop computer, laptop computer, netbook, or ultrabook.

Lens assembly 10 includes an upper lens structure portion 12, lower lens structure portion 14, and magnification lens 16. Lens assembly 10 is configured to be coupled to a housing 18 of the electronic device via a lens alignment structure 20 of housing 18. Lower lens structure portion 14 includes a lens attachment structure 22 adapted to be engaged with a housing attachment structure 24 of lens alignment structure 20. In one or more embodiments, lens attachment structure 22 and housing attachment structure 24 are configured to attach lens assembly 10 to housing 18 and align magnification lens 16 of lens assembly 10 with a camera lens 28 of a camera module 26 of the electronic device. In at least one embodiment, lens assembly 10 functions to magnify an object captured as an image by camera module 26 of the electronic device as further described herein.

Upper lens structure portion 12 is configured to be coupled to lower lens structure portion 14, and magnification lens 16 is configured to be held in place by the coupling of upper lens structure portion 12 to lower lens structure portion 14. In a particular embodiment, upper lens structure portion 12 is of a generally truncated conical shape having a substantially circular cross-section with respect to camera lens 28 of camera module 26. In still another particular embodiment, a circular cross-section of an upper portion of upper lens structure portion 12 disposed away from lower lens structure portion 14 is greater than a circular cross-section of a lower portion of upper lens structure portion 12 disposed proximate to lower lens structure portion 14. In at least one embodiment, upper lens structure portion 12 may include an opening in a lower portion thereof into which at least a portion of magnification lens 16 is disposed in order to hold magnification lens 16 in a predetermined position within lens assembly 10. In the particular embodiment as illustrated in FIG. 2B, the opening in the lower portion of upper lens structure portion 12 is substantially square in shape and magnification lens 16 includes a lower portion of substantially rectangular shape sized to be disposed within the substantially square opening. In still other embodiments, the opening in the lower portion of upper lens structure portion 12 and the magnification lens 16 may be of any desired shape.

In at least one particular embodiment, upper lens structure portion 12 may be configured to function as a lens hood for lens assembly 10. In another particular embodiment, upper lens structure portion 12 may be constructed at least in part of a transparent or semi-transparent material and may be configured to function as an illumination structure such as a light guide and/or light pipe to direct light to an object to increase the amount of light provided to camera lens 28 of camera module 26 during capturing of an image of the object. In a particular embodiment, upper lens structure portion 12 is constructed at least partially of a polycarbonate material.

Lower lens structure portion 14 is configured to be coupled to upper lens structure portion 12 and hold magnification lens 16 in place within lens assembly 10. In a particular embodiment, lower lens structure portion 14 is of a ring-like configuration having a substantially circular cross-section with respect to camera lens 28 of camera module 26. In still another particular embodiment, a circular cross-section of an upper portion of lower lens structure portion 14 disposed proximate to upper lens structure portion 14 is greater than a circular cross-section of a lower portion of lower lens structure portion 14 disposed away from upper lens structure portion 12. In a particular embodiment, at least a portion of lower lens structure portion 14 is constructed of a thermoplastic material, for example, polyamide 66 (PA66).

In some embodiments, magnification lens 16 is configured to be of a size and shape so as to function as a magnification or macro lens for camera module 26 by collecting light from an object or objects to form an image, magnifying the image, and provided the magnified image to camera module 26 so that the magnified image may be captured by camera module 26. In various embodiments, the captured magnified image may be stored and/or viewed by the electronic device to which lens assembly 10 is coupled. In a particular embodiment, magnification lens 16 includes a substantially convex upper surface and a substantially flat lower surface. In a particular embodiment, at least a portion of magnification lens 16 is constructed of a transparent or semi-transparent material, for example, poly(methyl methacrylate) (PMMA). In still other embodiments, any suitable lens configuration that is configured to provide magnification or any other desired transformation of an image may be used. In addition, although the illustrated embodiments are shown as using a single magnification lens 16, in other embodiments multiple lenses may be used. Further, although various embodiments are described as using a lens configured to magnify a captured image, in still other embodiments one or more lenses may be used to provide any desired image transformation to an image received from an object such as magnification, macro, zoom, fish-eye, and/or filtering of the image.

In various embodiments, lens alignment structure 20 is disposed upon or partially within housing 18 of the electronic device and lens attachment structure 22 of lower lens structure portion 14 is configured to engage housing attachment structure 24 of lens alignment structure 20. In at least one embodiment, lens attachment structure 22 and housing attachment structure 24 form a snap mechanism configured to allow lens assembly 10 to be snapped onto and firmly held to lens alignment structure 20. In one or more embodiments, lens alignment structure 20 functions to hold lens assembly 10 in a predetermined proper alignment with camera lens 28 of camera module 24 so that the lens assembly 10 may correctly perform the image transformation functions, such as magnification, described herein. In various embodiments, lens attachment structure 22 and housing attachment structure 24 of lens alignment structure 20 form one or more occlude structures configured to come into contact with cusps of opposing teeth of lens attachment structure 22 and housing attachment structure 24 as they are fitted together to securely hold and align lens assembly 10 with camera module 26. In a particular embodiment, lens attachment structure 22 is disposed along at least a portion of an inner circumference of lower lens structure portion 14. In some particular embodiments, housing attachment structure 24 is disposed along at least a portion of an outer circumference of lens alignment structure 20.

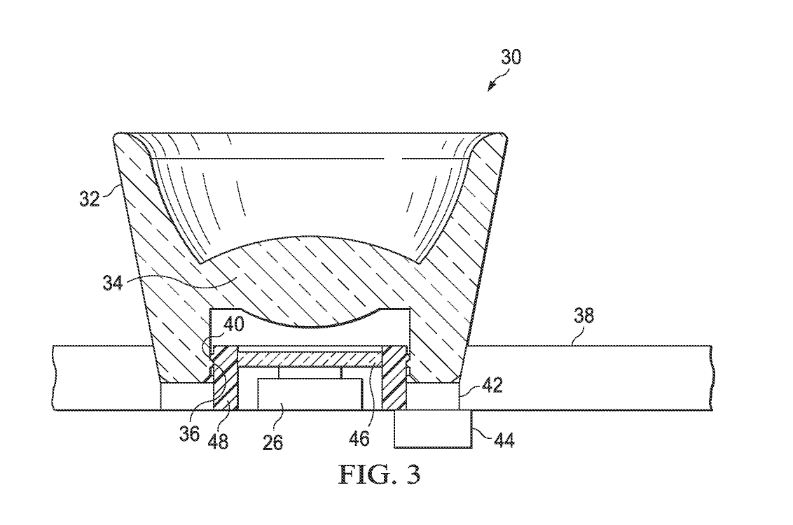

FIG. 3 is a simplified cross-sectional diagram illustrating another embodiment of an integrated lens assembly 30 of an auxiliary camera lens attachment for an electronic device. Integrated lens assembly 30 includes a integrated lens structure portion 32 having a magnification lens portion 34 integrally formed therewith such that integrated lens assembly 30 forms a single component. In various embodiments, integrated lens assembly 30 is constructed at least in part of a transparent or semi-transparent material. In a particular embodiment, magnification lens portion 34 is configured to be of a size and shape so as to function as a magnification or macro lens for camera module 26 by collecting light from an object or objects to form an image, magnifying the image, and provided the magnified image to camera module 26 so that the magnified image may be captured by camera module 26. In a particular embodiment, magnification lens portion 34 includes a substantially convex lower surface and a substantially convex lower surface. In one or more embodiments, the electronic device may include a transparent or semi-transparent camera lens protection structure 46 disposed between camera module 26 and integrated lens assembly 30.

Integrated lens assembly 30 is configured to be coupled with a housing 38 of the electronic device. Integrated lens structure portion 32 further includes a lens attachment structure 36 integrated therewith configured to engage a housing attachment structure 40 of a lens alignment structure 48. In one or more embodiments, lens alignment structure 48 is coupled to or disposed within housing 38. In at least one embodiment, lens attachment structure 36 and housing attachment structure 40 form a snap mechanism configured to allow integrated lens assembly 30 to be snapped onto and firmly held to lens alignment structure 48. In one or more embodiments, lens alignment structure 48 functions to hold integrated lens assembly 30 in proper alignment with camera lens 28 of camera module 24 so that integrated lens assembly 30 may correctly perform the image transformation functions, such as magnification, described herein. In a particular embodiment, lens attachment structure 36 is disposed along at least a portion of an inner circumference of lower portion of lens structure integrated lens structure portion 32. In some particular embodiments, housing attachment structure 40 is disposed along at least a portion of an outer circumference of lens alignment structure 48.

Housing 38 may further include a light pipe 42 disposed therein and coupled to an illumination module 44. Light pipe 42 is further coupled to a lower portion of integrated lens structure portion 32. Illumination module 44 is configured to emit light and provide the light to light pipe 42, and light pipe 42 is configured to provide the emitted light to integrated lens structure portion 32 during capture of an image by camera module 26. As a result, a surface of an object is further illuminated by light emitted by integrated lens structure portion 32 during capturing of an image of the object by camera module 26.

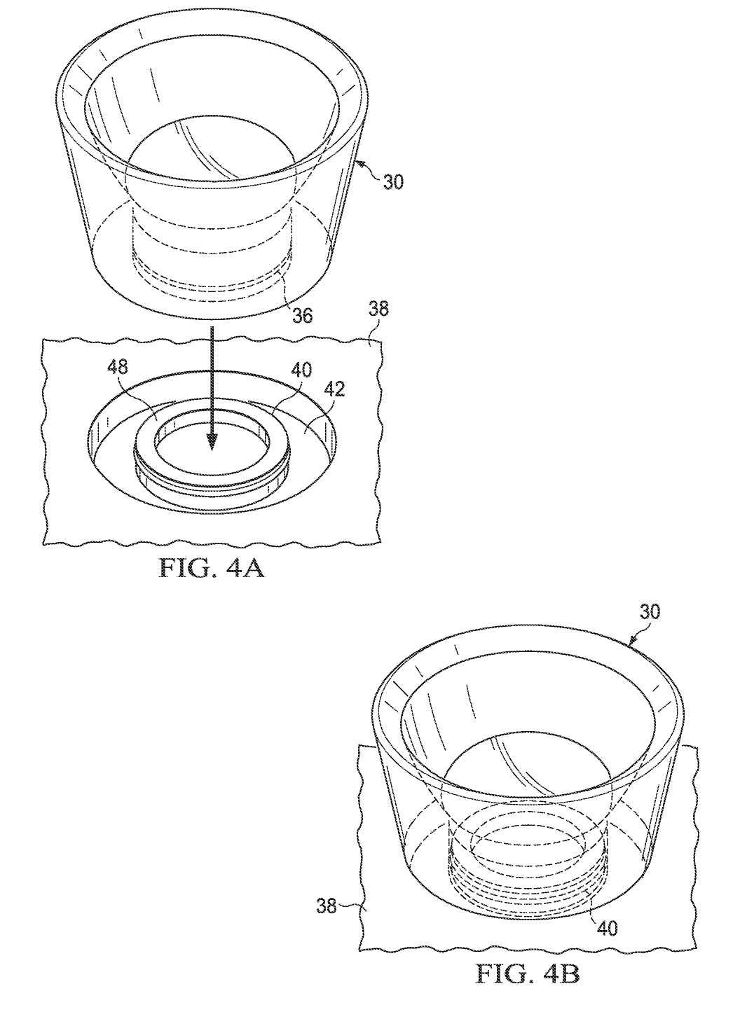

Referring now to FIGS. 4A-4B, FIGS. 4A-4B are simplified diagrams of an orthogonal view of an embodiment of the coupling of integrated lens assembly 30 of FIG. 3 to housing 38 of the electronic device. FIG. 4A illustrates an orthogonal view of integrated lens assembly 30 during a process of coupling integrated lens assembly 30 to housing 38. As show in FIG. 4A, integrated lens assembly 30 is aligned with lens alignment structure 48 of housing 38 of the electronic device during the coupling operation. FIG. 4B shows integrated lens assembly 30 coupled to housing 38 by lens alignment structure 48 in which lens attachment structure 36 of integrated lens structure portion 32 is engaged with housing attachment structure 40 of lens alignment structure 48 as a snap-on type configuration. In the snap-on configuration, light pipe 42 is coupled with the lower portion of integrated lens structure portion 32. The coupling of integrated lens assembly 30 to lens alignment structure 48 provides for a precise alignment of magnification lens portion 34 with respect to camera module 26 such that magnification lens portion 34 magnifies an image from an object captured by camera module 26. In addition, light emitted by illumination module 44 is provided to integrated lens structure portion 32 via light pipe 42, and the emitted light is further provided to the object via integrated lens structure portion 32 during an image capture operation. Although the illustrated embodiment is shown as using a single light pipe in a ring-configuration disposed around lens alignment structure 48, it should be understood that in other embodiments any desirable light pipe configuration may be used. For example, one or more light pipes may be disposed proximate to integrated lens structure portion 32 in some embodiments.

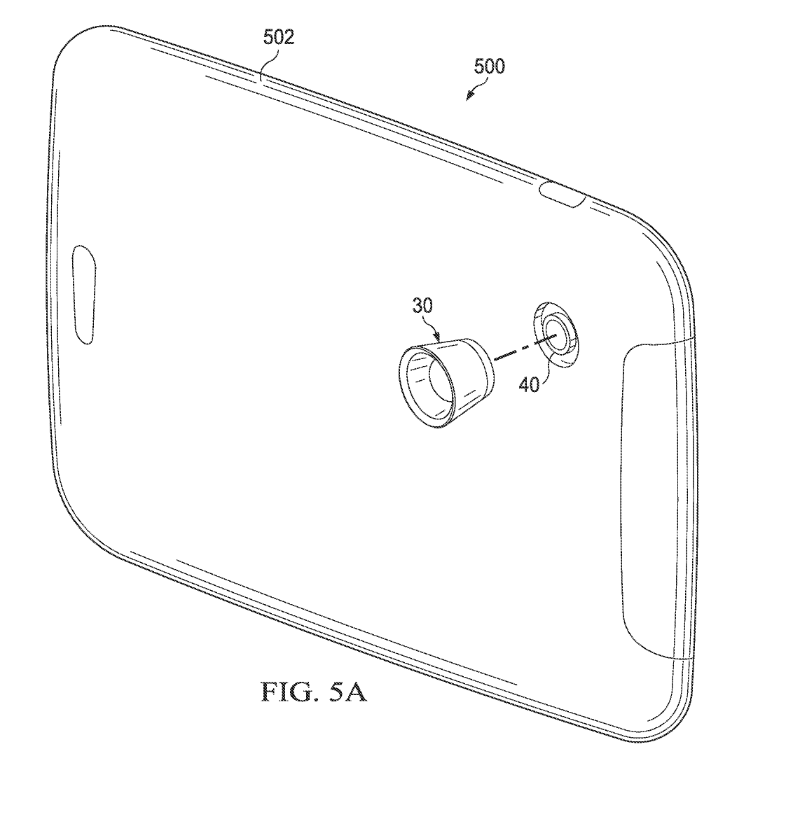

FIG. 5A is a simplified diagram illustrating an orthogonal rear view of an embodiment of an electronic device 500 configured to receive integrated lens assembly 30. In the particular embodiment illustrated in FIG. 5A, electronic device 500 is a tablet device having a housing attachment structure 40 configured to be coupled to integrated lens assembly 30 disposed within a back housing portion 502. In the embodiment illustrated in FIG. 5A, electronic device 500 includes a rear-facing camera. FIG. 5B is a simplified diagram illustrating an orthogonal front view of electronic device 500. As illustrated in FIG. 5B, electronic device 500 further includes a front housing portion 504. In the particular embodiment illustrated in FIG. 5B, front housing portion 504 includes a display 506 and a user interface 508. In at least one particular embodiment, display 506 includes a touch screen display and user interface 508 includes one or more buttons.

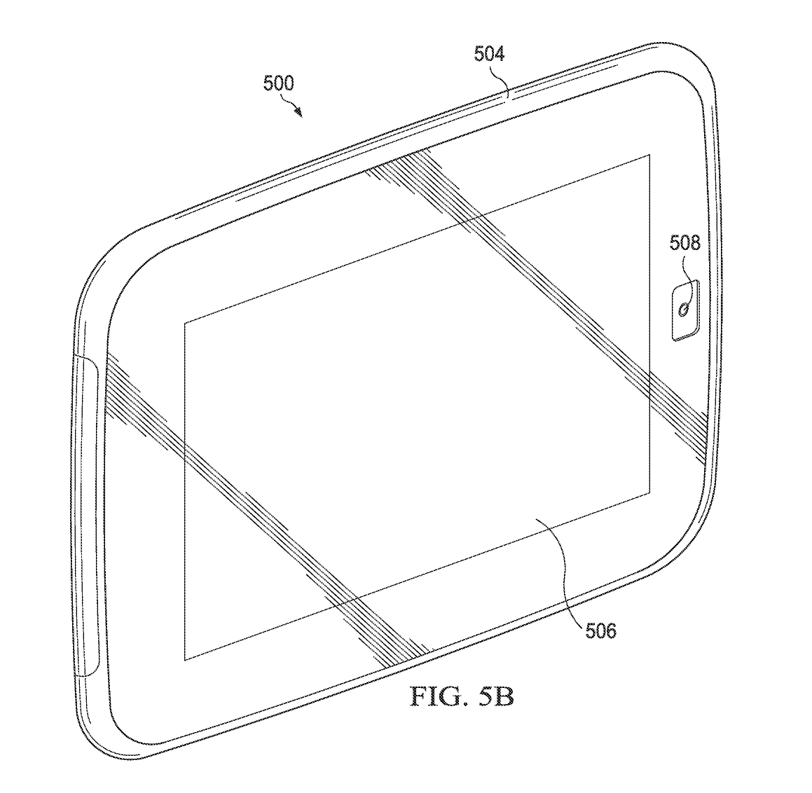

FIG. 6 is a simplified diagram illustrating an example operation of electronic device 500 of FIGS. 5A-5B. In FIG. 6, electronic device 500 is configured to capture an image of an object 602 with a camera module 26 (not shown) via integrated lens assembly 30. Electronic device 500 is further configured to display a magnified image 604 representative of a magnified version of a portion of object 602 to enable a more detailed observation of object 602 by a user of electronic device 500. In the particular embodiment illustrated in FIG. 6, object 602 is shown as a leaf, but it should be understood that in other embodiments any object may be used as a subject of study. Further, in one or more embodiments, electronic device 500 may be further configured to activate illumination module 44 during capture of the image of object 602 so as to enable integrated lens structure portion 32 of integrated lens assembly 30 to direct further illumination upon the surface of object 602. In one or more embodiments, a user may use one or more of the touch screen surface of display 502 or user interface 508 to control various aspects regarding the capturing, storing, and illumination of object 602.

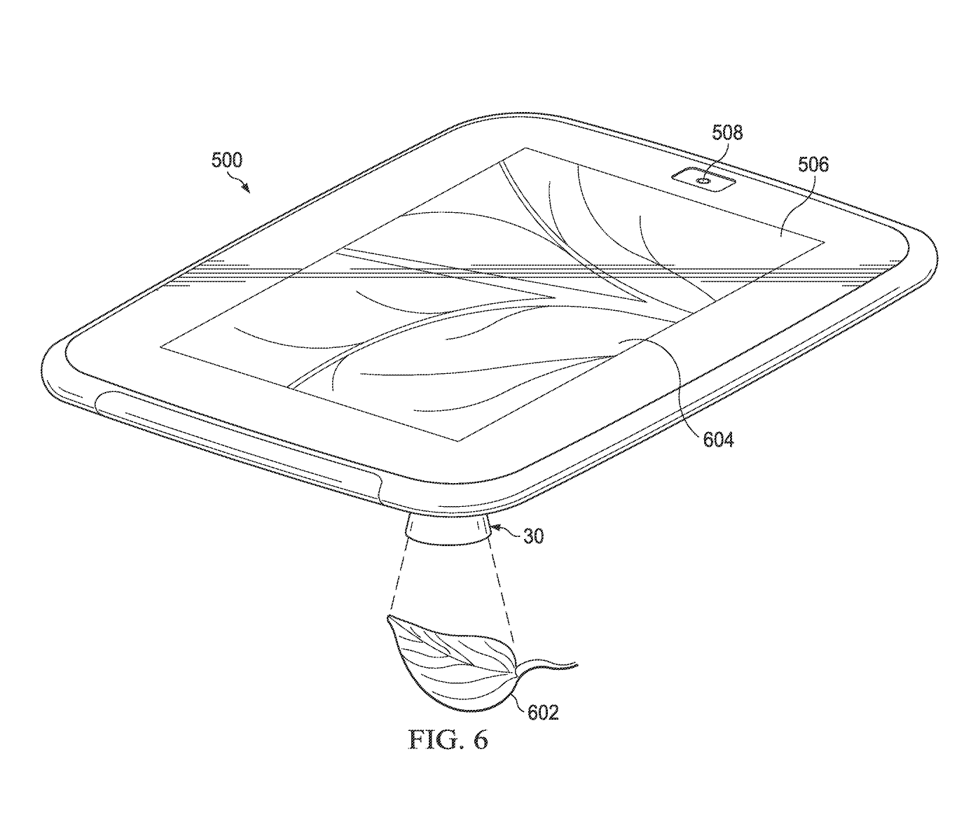

FIG. 7 is a simplified diagram illustrating an orthogonal front view of another embodiment of an electronic device 700 configured to receive integrated lens assembly 30 in an open configuration. In the embodiment illustrated in FIG. 7, electronic device 700 comprises a laptop computer shown in an open configuration. The electronic device 700 includes a lower housing 702 and an upper housing 704 coupled together via a hinge 706. Hinge 706 enables electronic device 700 to be positioned between an open configuration and a closed configuration. A keyboard 708 and touchpad 710 are disposed upon or within lower housing 702, and a display 712 is disposed upon or within upper housing 704. Upper housing 702 further includes integrated lens assembly 30 coupled to housing attachment structure of lens alignment structure 48. Lens alignment structure 48 is configured to hold integrated lens assembly within alignment with a camera module 26 (not shown) within upper housing 704. As described with respect to other embodiments, electronic device 700 is configured to capture an image of an object magnified by magnification lens portion 34 of integrated lens assembly 30 using camera module 26 and display the magnified image on display 712. In some embodiments, electronic device 700 may be further configured to activate illumination module 44 during capture of the image of object 602 so as to enable integrated lens structure portion 32 of integrated lens assembly 30 to direct further illumination upon the surface of the object. In one or more embodiments, the user of electronic device 700 may use one or more of keyboard 708 or the touchpad 710 to control various aspects regarding the capturing, storing, and illumination of the object.

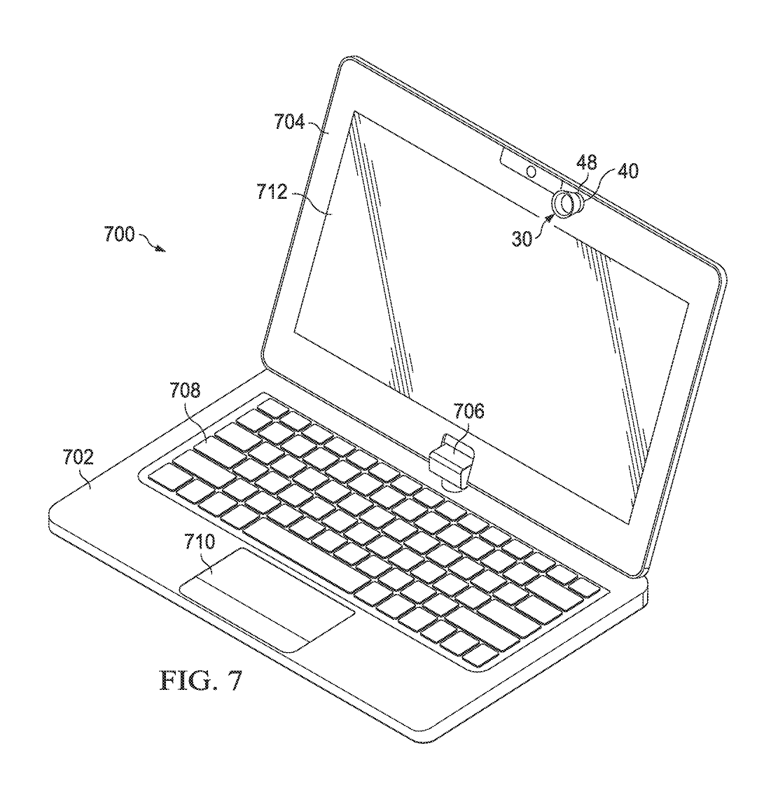

FIG. 8 is a simplified block diagram of an embodiment of an electronic device 800 configured to receive integrated lens assembly 30. In various embodiments, electronic device 800 may include one or more of electronic device 500 or electronic device 700 as previously described herein. Electronic device 800 includes one or more processors 802, memory element 804, camera module 806, illumination module 808, user interface module 810, display module 812, application module 814, and storage device 816. Processor(s)802 is configured to execute various tasks of electronic device 800 as described herein and memory element 804 is configured to store data associated with electronic device 800. Camera module 806 is configured to capture one or more transformed images received by a lens of the camera module 806 via one of the embodiments of lens assembly 10 or integrated lens assembly 30 fixedly coupled to electronic device 800 via one or more attachment structures as described herein. Lens assembly 10 or integrated lens assembly 30 is held within a predetermined alignment of the lens of camera module 806 via one or more lens alignment structures associated with electronic device 800. In a particular embodiment, camera module 808 may include camera module 26 as previously discussed. Illumination module 808 may be configured to provide illumination to integrated lens assembly 30 via one or more light pipes 42 in order to provide increased illumination to an object as image capture is performed. In at least one embodiment, illumination module 808 includes illumination module 44 of FIG. 3.

User interface module 810 is configured to provide a user interface to a user of electronic device 800 such as allowing a user to initiate an image capture operation, store a captured image, view a captured image, or activating illumination module 808. In various embodiments, user interface module 810 may include one or more of a keyboard, one or more buttons, a touch screen, a touchpad or any other suitable user interface device. Display module 812 is configured to display a captured image as magnified by integrated lens assembly 30 as well as provide other visual feedback to a user of electronic device 800. In various embodiments, display module 812 may include one or more of a liquid crystal display (LCD) device, a light emitting diode (LED) display device, an organic light emitting diode (OLED) display device, or any other suitable display device.

Application module 814 includes one or more software applications configured to control various aspects of electronic device 800. For example, application module 814 may include one or more software applications configured to control camera module 806, illumination module 808, user interface module 810, and/or display module 812. In particular embodiments, application module 814 may include one or more software applications configured to allow a user to manually control capture of an image by camera module 806, activation or enabling of illumination module 806, display of a magnified captured image by display module 812, storage of a captured image within storage device 816 and/or retrieval of a stored captured image from storage device 816. Storage device 816 is configured to store data associated with electronic device 800 including captured images, user data, and any other data. In various embodiments storage 816 may include one or more of a removable storage device, disc-based storage device, solid-state storage device or any other suitable storage device.

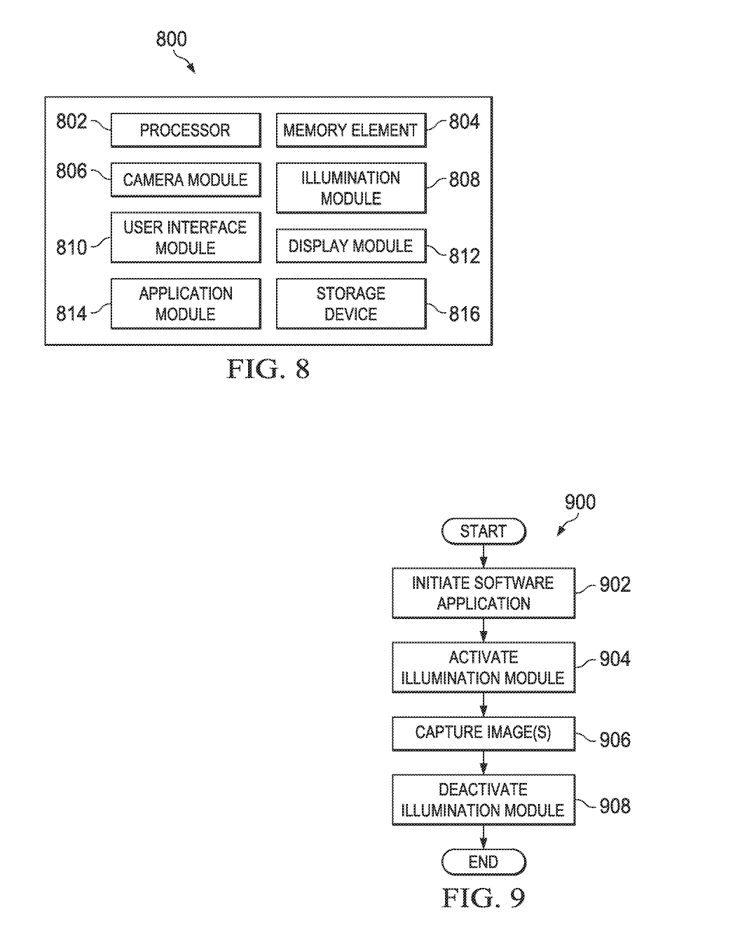

FIG. 9 is a flow diagram 900 illustrating an example operation of electronic device 800 having integrated lens assembly 30 coupled thereto. In 902, a software application for capturing images using camera module 806 is initiated. In 902, illumination module 808 is activated. Activation of illumination module 808 enables illumination to be provided from illumination module 808 to integrated lens structure 34 via light pipe 42 in order to illuminate an object under observation. In 906, one or more images is captured by camera module 806. The capture image(s) is obtained from the object and magnified or otherwise transformed by magnification lens portion 34 of integrated lens assembly 30 before being received by camera module 26. In still other embodiments, the integrated lens assembly 30 may include an image transformation portion instead of magnification lens portion 34 in which the image transformation portion is configured to receive an object image from an object, transform the object image according to the properties of the image transformation portion, and direct the transformed object image to camera module 26. In particular embodiments, the image transformation portion may perform one or more of any desired image transformation to the object image received from an object such as magnification, macro, zoom, fish-eye, and/or filtering of the object image before directing the transformed object image to camera module 26. In 908, illumination module 808 is deactivated and operation ends. The captured images may then be stored and/or view by a user of electronic device 800.

Various embodiments described herein provide for one or more occlude structures, such as one or more of alignment attachment structures 22, 36 and housing attachment structures 24, 40 of lens alignment structures 20, 48, to attach and align lens assembly 10 or integrated lens assembly 30 with a camera of an electronic device such as a mobile device. In some embodiments, this enables a more education usage of a standard camera of such mobile devices such as exploring the micro-world for scientific study. For example, attaching a macro-lens may help students use the electronic device as a microscope for close-up scientific study of objects. In some embodiments, the structure of integrated lens assembly 30 uses the transparent or semi-transparent construction of the integrated lens assembly 30 as a light pipe to provide additional light for the camera module to capture an image of the object under study. In still other embodiments, different lens configurations and filters may be used to adjust the optics and viewing conditions for entertainment or scientific inquiry usages of the electronic device. As discussed above, in one or more embodiments, the occlude structure can be used alone or in combination with an optional light source placed under the lens that will transform the lens structure into a light pipe that may be useful in the illumination of objects for magnification.

Some embodiments may provide for one or more advantages such as a simple and reliable structure, a cost effective single-part solution which may not add much if any cost to camera devices. Another advantage that may be provide by some embodiments include that the lens assembly may be easy to use by only requiring the clicking or snapping-on of the lens assembly while further providing alignment of the lens assembly with the camera module of the electronic device. Another advantage that may be provided by some embodiments include that the lens assembly may be of an environmentally friendly and/or green design by being easy to manufacture and requiring no adhesives such as glues or adhesive tapes. Another advantage that may be provided by some embodiments is that it may smartly uses the transparent or semi-transparent lens assembly itself as a light pipe to provide light for the camera to capture an image of the object.

It is imperative to note that all of the specifications, dimensions, and relationships outlined herein (e.g., height, width, length, materials, etc.) have only been offered for purposes of example and teaching only. Each of these data may be varied considerably without departing from the spirit of the present disclosure, or the scope of the appended claims. Any suitable length, width, and depth (or height) may be used and can be based on particular end user needs, or specific elements to be addressed by the apparatus (or the system in which it resides). The specifications apply only to one non-limiting example and, accordingly, they should be construed as such. In the foregoing description, example embodiments have been described. Various modifications and changes may he made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Example Embodiment Implementations

One particular example implementation provides for an electronic computing device including a processor, a memory element, a camera module, and a housing including an alignment structure associated therewith for aligning a lens with the camera module. The electronic computing devices further includes a housing attachment structure associated with the alignment structure for attaching the lens to the housing. The lens includes a first structure portion including a lens attachment structure, and an image transformation portion coupled to the first structure. The lens attachment structure is configured to engage the housing attachment structure, and the alignment structure is configured to position the image transformation portion in a predetermined alignment with the camera module.

In another particular example, the image transformation portion comprises a magnification lens portion. In another particular example, the electronic computing device further comprises an illumination source, wherein the first structure portion is further configured to be positioned proximate to the illumination source. In another particular example, the electronic computing device further comprises a light pipe disposed within the housing, wherein the first structure portion is configured to be coupled to the illumination source via the light pipe.

In another particular example, the first structure portion and image transformation portion are integrated as a single component. In another particular example, the lens further includes a second structure portion coupled to the first structure portion, a portion of the image transformation portion being disposed between the first structure portion and the second structure portion. In another particular example, the lens attachment structure and housing attachment structure form a snap mechanism configured to allow the lens to be snapped onto and held to the alignment structure. In another particular example, the lens attachment structure is disposed along at least a portion of an inner circumference of the first structure portion. In another particular example, the housing attachment structure is disposed along at least a portion of an outer circumference of the alignment structure.

In another particular example, the image transformation portion is configured to receive an object image, transform the object image, and direct the transformed object image to the camera module. In another particular example, the camera module is configured to capture the transformed object image. In another particular example, the electronic computing device further comprises a display device configured to display the transformed object image.

In another particular example configuration, a lens apparatus for an electronic computing device including a camera module is provided in which the lens apparatus includes a first structure portion including a lens attachment structure, an image transformation portion coupled to the first structure, and an illumination structure coupled to the first structure portion and configured to direct light to an object from an illumination source. The lens attachment structure is configured to engage a housing attachment structure of an alignment structure associated with a housing of the electronic computing device. The alignment structure is configured to position the image transformation portion in a predetermined alignment with the camera module of the electronic computing device and position the first structure portion in a predetermined alignment with the illumination source.

In another particular example, the image transformation portion comprises a magnification lens portion. In another particular example, the first structure portion is configured to be coupled to the illumination source via a light pipe disposed within the housing of the electronic device. In another particular example, the first structure portion and image transformation portion are integrated as a single component. In another particular example, a portion of the image transformation portion is disposed between the first structure portion and the illumination structure.

In another particular example, the lens attachment structure is disposed along at least a portion of an inner circumference of the first structure portion. In another particular example, the image transformation portion is configured to receive an object image, transform the object image, and direct the transformed object image to the camera module.

In another particular example configuration, a lens apparatus for an electronic computing device including a camera module is provided in which the lens apparatus includes a structure portion including a lens attachment structure, and an image transformation portion integrated with the structure portion. The lens attachment structure is configured to engage a housing attachment structure of an alignment structure associated with a housing of the electronic computing device. The alignment structure configured to position the image transformation portion in a predetermined alignment with the camera module of the electronic computing device.

In another particular example, the image transformation portion comprises a magnification lens portion. In another particular example, the structure portion is configured to direct light to an object from an illumination source. In another particular example, the structure portion is configured to be coupled to the illumination source via a light pipe disposed within the housing of the electronic device. In another particular example, the image transformation portion is configured to receive an object image, transform the object image, and direct the transformed object image to the camera module. In another particular example, the lens attachment structure is disposed along at least a portion of an inner circumference of the structure portion.

What is claimed is:

1. An electronic computing device, comprising:
a processor;
a memory element;
a camera module;
a housing including an alignment structure associated therewith for aligning a lens with the camera module; and
a housing attachment structure associated with the alignment structure for attaching the lens to the housing; and
wherein the lens includes:
a first structure portion including a lens attachment structure; and
an image transformation portion coupled to the first structure;
wherein the lens attachment structure is configured to engage the housing attachment structure, and the alignment structure is configured to position the image transformation portion in a predetermined alignment with the camera module.

2. The electronic computing device of claim 1, wherein the image transformation portion comprises a magnification lens portion.

3. The electronic computing device of claim 1, further comprising an illumination source, wherein the first structure portion is further configured to be positioned proximate to the illumination source.

4. The electronic computing device of claim 3, further comprising a light pipe disposed within the housing, wherein the first structure portion is configured to be coupled to the illumination source via the light pipe.

5. The electronic computing device of claim 1, wherein the first structure portion and image transformation portion are integrated as a single component.

6. The electronic computing device of claim 1, wherein the lens further includes a second structure portion coupled to the first structure portion, a portion of the image transformation portion being disposed between the first structure portion and the second structure portion.

7. The electronic computing device of claim 1, wherein the lens attachment structure and housing attachment structure form a snap mechanism configured to allow the lens to be snapped onto and held to the alignment structure.

8. The electronic computing device of claim 1, wherein the lens attachment structure is disposed along at least a portion of an inner circumference of the first structure portion.

9. The electronic computing device of claim 1, wherein the housing attachment structure is disposed along at least a portion of an outer circumference of the alignment structure.

10. The electronic computing device of claim 1, wherein the image transformation portion is configured to receive an object image, transform the object image, and direct the transformed object image to the camera module.

11. The electronic computing device of claim 10, wherein the camera module is configured to capture the transformed object image.

12. The electronic computing device of claim 11, further comprising a display device configured to display the transformed object image.

13. A lens apparatus for an electronic computing device including a camera module, comprising:
a first structure portion including a lens attachment structure;
an image transformation portion coupled to the first structure;
an illumination structure coupled to the first structure portion and configured to direct light to an object from an illumination source;
wherein the lens attachment structure is configured to engage a housing attachment structure of an alignment structure associated with a housing of the electronic computing device, the alignment structure configured to position the image transformation portion in a predetermined alignment with the camera module of the electronic computing device and position the first structure portion in a predetermined alignment with the illumination source.

14. The lens apparatus of claim 13, wherein the image transformation portion comprises a magnification lens portion.

15. The lens apparatus of claim 13, wherein the first structure portion is configured to be coupled to the illumination source via a light pipe disposed within the housing of the electronic device.

16. The lens apparatus of claim 13, wherein the first structure portion and image transformation portion are integrated as a single component.

17. The lens assembly of claim 13, wherein a portion of the image transformation portion is disposed between the first structure portion and the illumination structure.

18. The lens assembly of claim 13, wherein the lens attachment structure is disposed along at least a portion of an inner circumference of the first structure portion.

19. The lens assembly of claim 13, wherein the image transformation portion is configured to receive an object image, transform the object image, and direct the transformed object image to the camera module.

20. A lens apparatus for an electronic computing device including a camera module, comprising:
a structure portion including a lens attachment structure; and
an image transformation portion integrated with the structure portion;
wherein the lens attachment structure is configured to engage a housing attachment structure of an alignment structure associated with a housing of the electronic computing device, the alignment structure configured to position the image transformation portion in a predetermined alignment with the camera module of the electronic computing device.

21. The lens apparatus of claim 20, wherein the image transformation portion comprises a magnification lens portion.

22. The lens assembly of claim 20, wherein the structure portion is configured to direct light to an object from an illumination source.

23. The lens apparatus of claim 23, wherein the structure portion is configured to be coupled to the illumination source via a light pipe disposed within the housing of the electronic device.

24. The lens assembly of claim 20, wherein the image transformation portion is configured to receive an object image, transform the object image, and direct the transformed object image to the camera module.

25. The lens assembly of claim 20, wherein the lens attachment structure is disposed along at least a portion of an inner circumference of the structure portion.
